(19) United States
(12) Patent Application Publication
(10) Pub. No.: US 2018/0236939 A1
(43) Pub. Date: Aug. 23, 2018

(54) Method, System, and Device for a Forward Vehicular Vision System

(71) Applicant: Kevin Anthony Smith, Cincinnati, OH (US)

(72) Inventor: Kevin Anthony Smith, Cincinnati, OH (US)

(21) Appl. No.: 15/439,160

(22) Filed: Feb. 22, 2017

(51) Int. Cl. B60R 1/00; H04N 7/18; H04N 5/232

(52) U.S. Cl. CPC B60R 1/00; H04N 7/183; G06K 9/00805; B60R 2300/802; H04N 5/23293

(57) ABSTRACT

A method, system, and device for a forward vehicular vision system, permitting a driver to view forward of the vehicle. The device provides the visual field forward of the vehicle and also extends the visual field to view areas, regions, and/or objects which are forward to allow a line of sight that might otherwise be blocked by an obstruction causing a blocked angle.

### CROSS-REFERENCE TO RELATED APPLICATION

Not Applicable

### FEDERALLY SPONSORED RESEARCH

Not Applicable

### REFERENCE TO SEQUENCE LISTING

Not Applicable

### FIELD OF THE INVENTION

The present invention relates to vehicular viewing methods, systems, and devices and more particularly pertains to a new forward-viewing method, system, and device for vehicles.

### BACKGROUND OF THE INVENTION

Many automobile accidents are consequences of human error rather than mechanical failure. This is especially true with today's state-of-the-art automotive amenities which have virtually eliminated the possibility of accidents occurring as a result of technological malfunction. Still, the automotive industry continues to focus on improved safety features for motor vehicles by designing mechanisms to protect both drivers and passengers, making for safer driving conditions.

Vehicular accidents are commonly caused during the passing and overtaking of vehicles that are anterior to one's own vehicle. Safety hazards are created when large and/or wide vehicles block the visual field available to the vehicle in the posterior position, obstructing the view of the driver. Moreover, fatalities often occur from head-on collisions on two-lane roadways where passing is permitted, from rear-end collisions during lane changes where traffic has stopped in adjacent lanes, and from side collisions during left turns at intersections of multi-lane roadways, when the oncoming traffic is not visible to the driver. It has heretofore been necessary to direct the vehicle slightly into the adjacent lane on the right or left in order to assure safe passage into another lane.

The ability to see other vehicles is an important aspect in accident prevention. Furthermore, having adequate views to the rear of, alongside, and/or forward of one's vehicle is essential to safe operation. These views are obtained in a less hazardous manner when the driver is not required to make dangerous movement into another lane in order to obtain a greater visual field prior to making turns or passing vehicles immediately ahead of them due to a forward obstruction that causes blocking to the forward line of sight—henceforth known as a blocked angle. In particular, the driver's line of sight is more susceptible to obstruction by larger vehicles and prone to a blocked angle on the passenger side of the vehicle, making lane changes toward the passenger-side direction even more dangerous. Moreover, recognition of the blocked angles created by a forward obstruction is critical to vehicular safety as lane changes are often made at high speeds.

It is extremely problematic and presents a dangerous situation when drivers cannot see what is happening in front of them because a large vehicle, such as an SUV, van, bus, or truck, pulls in front of them on the roadway. These large vehicles can block the driver's vision of the traffic further up the roadway. The driver cannot get any advance warning by spotting brake lights of vehicles in a blocked angle beyond the large vehicle. When a driver slows down, they must rely on the proper and timely braking of the large vehicle for warning of road hazards, as the driver cannot see the roadway in a blocked angle beyond the large vehicle obstructing their vision. If a driver can see through the back and front window of the vehicle which pulled in front of them, less of a hazard exists. However, even with ‘defensive driving,’ where a driver leaves a car length between them and the vehicle in front of them for every 10 miles per hour they are traveling, the blocked angle is created by larger vehicles that obstruct the forward line of sight.

It is known to use image capture devices on a vehicle to capture images both interior to the vehicle and exterior to the vehicle. It is also known to process the images of such image capture devices by a variety of controls in order to display said images to a driver or another occupant of the vehicle, or to utilize the output of an image capture device in order to generate control signals for a vehicular accessory. Thus, the use of image capture device systems, image processing systems, display systems, as well as other vehicular viewing mechanisms are known in the prior art. More specifically, vehicular viewing mechanisms heretofore devised and utilized are known to consist basically of familiar, expected and obvious structural configurations, notwithstanding the myriad of designs encompassed by the crowded prior art which have been developed for the fulfillment of countless objectives and requirements. Prior art shows previous attempts at various image capture devices and control systems, but none address the targeted objectives described herein which presently indicate an unmet need that has yet to be offered on the market. It may be desirable to provide a method, system, and device for forward-viewing which provides the visual field of significant areas and/or objects that would otherwise not be viewable to the driver and thus overcomes the various drawbacks of the prior art.

To avoid a collision between a vehicle and other vehicles or objects, it is very important to detect an obstacle or obstruction on a forward pathway of the vehicle in order to judge whether or not the road condition is safe. One of the most dangerous situations confronting law enforcement and emergency vehicles such as ambulances, fire trucks, and police cars, during high-speed emergency responses, is the lack of forward view due to a blocked angle. Emergency responses often take place during high-traffic hours and may contain many obstructions alongside inclement weather and unpredictable road conditions. Road width, terrain, traffic, and other situations can prevent emergency and law enforcement vehicles from obtaining a clear path. This can create a problem when a quick response is necessary for a life-threatening situation. These situations are very dangerous not only for the emergency and law enforcement vehicles, but civilian vehicles, as well. Providing an increased forward line of sight can reduce the risk of injury to law enforcement and emergency vehicles, as well as civilian drivers and pedestrians.

A long-felt need in the art of vehicular vision systems has been commercial acceptance of the elimination of exterior mirrors by utilizing image capture devices in combination with displays. This would be beneficial because it would reduce wind drag, wind noise, and vehicle weight, and increase fuel efficiency. Furthermore, exterior mirrors protrude a substantial distance from the side of the vehicle, which makes maneuvering in tight spaces more difficult. Image capture devices are capable of positioning in a greater variety of locations on the vehicle, providing more flexibility of vehicle styling. It is further expected, as documented by prior art, that image capture devices would greatly reduce the blind spots to the sides and rear of the vehicle common with vehicles equipped with conventional rearview mirror systems. Exterior mirrors can impede driving when a driver cannot perceive vehicles, objects, or other road users in such blind spots without turning his or her body, which interferes with forward-looking visual activities.

With the rapid development and sophistication of technology, it may be appropriate to consider a vehicular vision system that enables a driver to obtain a forward line of sight. In the course of the onset of commercial acceptance of mirrorless cars, it is advantageous for drivers to have a vehicular vision system that displays more than the rearward view and areas surrounding the car as shown in the prior art. More importantly, a line of sight in the forward direction including areas that would otherwise be blocked by an obstruction in front of the vehicle is supremely beneficial. Furthermore, as autonomous vehicles become commercially accepted, a vehicular vision system that displays a forward view can help alleviate fear and anxiety in the occupants, enabling them to feel a greater sense of safety as they move in the forward traveling direction at high speeds.

Many mechanisms have been proposed and constructed to provide drivers with features that help make operating a vehicle safer. These include vehicle-to-vehicle communication, vehicle-to-infrastructure communication, radars, lasers, ultrasonic waves, RFID chips, and image capture devices with display systems. Although often providing results, these devices also have several shortcomings. For example and without limitation, although vehicle-to-vehicle communication, vehicle-to-infrastructure communication, radars, lasers, ultrasonic waves, and RFID chips can provide warnings of an object in the surrounding area of a vehicle, visual location via an actual image of the distance to another object, such as a vehicle in an adjacent lane, is primitive to driving safety when factors such as speed, weather conditions, and an individual driver's ability are considered.

Furthermore, where blind spot detection can be covered by these devices, having a vehicular vision system that displays a forward view, as opposed to only a predetermined and restricted detecting range, is necessary when traveling at high speeds of 30, 40, 50, and 60 mph because the forward adjacent lane may contain slow or stopped traffic which would not allow for a car having an obstructed view and changing lanes to decelerate in enough time to come to a complete stop, thus resulting in an accident. In view of the foregoing disadvantages inherent in the known types of systems now present in the prior art, the present invention provides a new vehicular vision system wherein the same can be utilized for viewing a blocked angle of a vehicle enabling a driver to obtain a view of the road conditions beyond a view-obstructing vehicle.

The prior art displays many image capture and display systems that present views of the blind spots and surrounding areas of a vehicle that do not provide the necessary forward line of sight including areas in a blocked angle caused from an obstruction in front of a vehicle. A vehicular vision system that provides a line of sight that extends substantially beyond the surrounding area of a car and displays a view that would not be visible when a forward obstruction is in front of a vehicle is superior, particularly when traveling at high speeds which require more time to decelerate in the event of slow or stopped traffic, or objects in an adjacent lane. Other prior art presents systems that display multiple views surrounding a vehicle on one display system or require a driver to select which direction is to be viewed. A constant display on a display system is more reliable as multiple views can crowd a display system, creating a visual burden and causing confusion as to which direction is being viewed by the driver. Moreover, view selection adds operational burden to the driver if they have to select the view to be displayed.

Additionally, other prior art produces results that display bird's eye views, top views, and tilted perspectives on the display system. A natural view that displays a visual field of considerably normal viewing perspective to the driver is advantageous because it offers an undistorted, plain view that is accurate and familiar for the driver, making it easy to quickly interpret since it is consistent with the true-to-life, true-to-scale viewing perspective. Still, other prior art links a display system to the activity of a turn signal which can cause confusion on the roadway when used unnecessarily or excessively to check adjacent lanes. A constant image display system is valuable because a driver does not have to use their turn signal to check if a lane is safe to pass into since a constant image provides a visualization that can be seen and quickly referenced at all times, thus providing an easy-to-grasp display so as to prevent the driver from being puzzled or making an erroneous judgement. Even still, other prior art uses side view mirrors which cause drag, wind noise, and lower fuel efficiency. The present invention can be utilized on mirrorless vehicles for aerodynamic and aeroacoustic utility.

While these devices fulfill their respective, particular objectives and requirements, the aforementioned prior art does not disclose the present vehicular vision system. In these respects, the forward vehicular vision system according to the present invention substantially departs from the conventional concepts and designs of the prior art, and in so doing provides a method, system, and device primarily developed for the purpose of viewing the visual field forward of the vehicle, the visual field forward of the vehicle including areas that would otherwise be blocked by an obstruction in front of the vehicle.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### Principle Objects of the Invention

It is a first object of the present invention to provide a new forward vehicular vision system for a vehicle which overcomes some or all of the previously delineated disadvantages of the prior art.

It is a second object of the present invention to provide a new forward vehicular vision system which improves the visual field by providing a driver with an efficacious view of objects forward and/or alongside of the vehicle.

It is a third object of the present invention to provide a new forward vehicular vision system which gives the driver of a vehicle an improved line of sight with respect to objects ahead of the vehicle without requiring the driver to significantly direct the vehicle into an adjacent lane in order to view the traffic conditions that would otherwise be obstructed by preceding objects and/or vehicles.

It is another object of the present invention to provide a new forward vehicular vision system that can be attached to a vehicle for providing the driver thereof with an enhanced visual field.

Still another object of the present invention is to provide a new forward vehicular vision system that provides a display to enable usage for a wide variety of people.

Yet another object of the present invention is to provide a new forward vehicular vision system which permits relatively safe forward viewing while utilizing conventional and/or modern material and equipment to manufacture the apparatus.

### BRIEF SUMMARY OF THE INVENTION

These, and other objects, are achieved by a forward vehicular vision system which in lieu of the preferred embodiment consists of a method, system, and device for displaying a visual field forward of a vehicle, the visual field forward of the vehicle including areas that would otherwise be blocked by an obstruction in front of the vehicle, the device comprising, at least one image input apparatus and at least one image output apparatus involving: attaching at least one image input apparatus to a vehicle for acquiring images, and displaying said images on at least one image output apparatus within the vehicle. Each image input apparatus is capable of acquiring both immobile and mobile objects as well as objects that increase driving performance (e.g. traffic signs, intersections, junctions, entrances, street lights, parking opportunities, etc.) and objects that do not directly relate to the driving action, but rather serve commercial purposes and/or belong to the general infrastructure (e.g. mailboxes, signs, stores, houses, etc.).

The present invention utilizes at least one image input apparatus to acquire images in the forward field of view of the vehicle. The acquired images are displayed on at least one image output apparatus within the vehicle, displaying a forward field of view including a line of sight that would otherwise be blocked by an obstruction in front of the vehicle. The positioning of any of at least one image output apparatus can be separate or combined with present display systems within a vehicle in order to differentiate between any other views being displayed, thus creating a distinction in the viewing perspective for the forward vehicular vision system. The forward vehicular vision system can utilize a combined image or separate image(s) to make either one overall image or isolated image(s) on at least one image output apparatus.

The forward vehicular vision system displays a readily available forward field of view so that the forward area can be viewed with just one glance. The positioning of the forward vehicular vision system enhances a driver's view while maintaining substantially the same visual perspective as would be seen by ordinary visualization, so that objects can be seen from a considerable distance without the driver having to move the vehicle significantly into an adjacent lane. Also, the option to use vehicular vision system engineering known to those skilled in the art enables past technology to be incorporated into the architecture whereby conventional and modern vehicular vision system assembly configuration can be improved upon to provide optimal results for an enhanced forward view during operation of a vehicle.

It may therefore be desirable to allow a user of a vehicle to view certain areas and/or objects which are located or disposed in the front and/or along the side of the vehicle, thereby allowing the user to gain additional images or information over that which is traditionally and/or typically provided by present-day vehicular systems. This additional information may be useful in the navigation and/or operation of the vehicle.

### BRIEF DESCRIPTION OF THE DRAWING FIGURES

FIG. 1 is a schematic front perspective view of a first possible mounted position for at least one image input apparatus of the forward vehicular vision system according to the present invention.

FIG. 2 is a schematic front perspective view of a second possible mounted position for at least one image input apparatus of the forward vehicular vision system according to the present invention.

FIG. 3 is a schematic front perspective view of a third possible mounted position for at least one image input apparatus of the forward vehicular vision system according to the present invention.

FIG. 4 is a schematic front perspective view of a fourth possible mounted position for at least one image input apparatus of the forward vehicular vision system according to the present invention.

FIG. 5 is a schematic front perspective view of a fifth possible mounted position for at least one image input apparatus of the forward vehicular vision system according to the present invention.

FIG. 6 is a schematic front perspective view of a sixth possible mounted position for at least one image input apparatus of the forward vehicular vision system according to the present invention.

FIG. 7 is a schematic front perspective view of a seventh possible mounted position for at least one image input apparatus of the forward vehicular vision system according to the present invention.

FIG. 8 is a schematic front perspective view of an eighth possible mounted position for at least one image input apparatus of the forward vehicular vision system according to the present invention.

FIG. 9 is a schematic front perspective view of a ninth possible mounted position for at least one image input apparatus of the forward vehicular vision system according to the present invention.

FIG. 10 is a schematic front perspective view of a tenth possible mounted position for at least one image input apparatus of the forward vehicular vision system according to the present invention.

FIG. 11 is a schematic front perspective view of a first possible impressed position for at least one image input apparatus of the forward vehicular vision system according to the present invention.

FIG. 12 is a schematic front perspective view of a second possible impressed position for at least one image input apparatus of the forward vehicular vision system according to the present invention.

FIG. 13 is a schematic front perspective view of a third possible impressed position for at least one image input apparatus of the forward vehicular vision system according to the present invention.

FIG. 14 is a schematic front perspective view of a fourth possible impressed position for at least one image input apparatus of the forward vehicular vision system according to the present invention.

FIG. 15 is a schematic front perspective view of a fifth possible impressed position for at least one image input apparatus of the forward vehicular vision system according to the present invention.

FIG. 16 is a schematic front perspective view of a sixth possible impressed position for at least one image input apparatus of the forward vehicular vision system according to the present invention.

FIG. 17 is a schematic front perspective view of a seventh possible impressed position for at least one image input apparatus of the forward vehicular vision system according to the present invention.

FIG. 18 is a schematic front perspective view of an eighth possible impressed position for at least one image input apparatus of the forward vehicular vision system according to the present invention.

FIG. 19 is a schematic front perspective view of a ninth possible impressed position for at least one image input apparatus of the forward vehicular vision system according to the present invention.

FIG. 20 is a schematic front perspective view of a tenth possible impressed position for at least one image input apparatus of the forward vehicular vision system according to the present invention.

FIG. 21 is a schematic front perspective view of a first possible multi-view position for at least one image input apparatus of the forward vehicular vision system according to the present invention.

FIG. 22 is a schematic front perspective view of a second possible multi-view position for at least one image input apparatus of the forward vehicular vision system according to the present invention.

FIG. 23 is a schematic front perspective view of a third possible multi-view position for at least one image input apparatus of the forward vehicular vision system according to the present invention.

FIG. 24 is a schematic front perspective view of a fourth possible multi-view position for at least one image input apparatus of the forward vehicular vision system according to the present invention.

FIG. 25 is a schematic front perspective view of a fifth possible multi-view position for at least one image input apparatus of the forward vehicular vision system according to the present invention.

FIG. 26 is a schematic front perspective view of a sixth possible multi-view position for at least one image input apparatus of the forward vehicular vision system according to the present invention.

FIG. 27 is a schematic front perspective view of a seventh possible multi-view position for at least one image input apparatus of the forward vehicular vision system according to the present invention.

FIG. 28 is a schematic front perspective view of an eighth possible multi-view position for at least one image input apparatus of the forward vehicular vision system according to the present invention.

FIG. 29 is a schematic front perspective view of a ninth possible multi-view position for at least one image input apparatus of the forward vehicular vision system according to the present invention.

FIG. 30 is a schematic front perspective view of a tenth possible multi-view position for at least one image input apparatus of the forward vehicular vision system according to the present invention.

FIG. 31 is a schematic top perspective view of a first possible position disposed along the side of a vehicle for at least one image input apparatus of the forward vehicular vision system according to the present invention.

FIG. 32 is a schematic top perspective view of a second possible position disposed along the side of a vehicle for at least one image input apparatus of the forward vehicular vision system according to the present invention.

FIG. 33 is a schematic top perspective view of a third possible position disposed along the side of a vehicle for at least one image input apparatus of the forward vehicular vision system according to the present invention.

FIG. 34 is a schematic top perspective view of a fourth possible position disposed along the side of a vehicle for at least one image input apparatus of the forward vehicular vision system according to the present invention.

FIG. 35 is a schematic top perspective view of a fifth possible position disposed along the side of a vehicle for at least one image input apparatus of the forward vehicular vision system according to the present invention.

FIG. 36 is a schematic top perspective view of a sixth possible position disposed along the side of a vehicle for at least one image input apparatus of the forward vehicular vision system according to the present invention.

FIG. 37 is a view illustrating a displayed image of a left blocked angle on a display of the forward vehicular vision system according to the present invention.

FIG. 38 is a view illustrating a displayed image of a right blocked angle on a display of the forward vehicular vision system according to the present invention.

FIG. 39 is a view illustrating the visual field forward, depicting the obstructed line of sight of a driver and the line of sight of a left and right blocked angle, illustrating a principle in accordance with the teaching of the present invention.

FIG. 40 is a view illustrating a displayed image of a possible visual field forward depicting the obstructed line of sight of a driver and the line of sight of a left and right blocked angle on a display of the forward vehicular vision system according to the present invention.

FIG. 41 is a view illustrating a displayed image of a possible overall visual field forward on a display of the forward vehicular vision system according to the present invention.

FIG. 42 is a schematic plan view of the forward vehicular vision system, illustrating a principle in accordance with the teaching of the present invention.

### DESCRIPTION OF THE PREFERRED EMBODIMENT

The present invention can be employed on automobiles such as cars, trucks and buses, and vehicles other than automobiles, as well as for commercial, emergency, military, and government vehicles, and for industrial uses such as on construction equipment or warehouse moving equipment. Other objects, features and advantages of the invention will become apparent from a consideration of the following detailed description and the accompanying drawings.

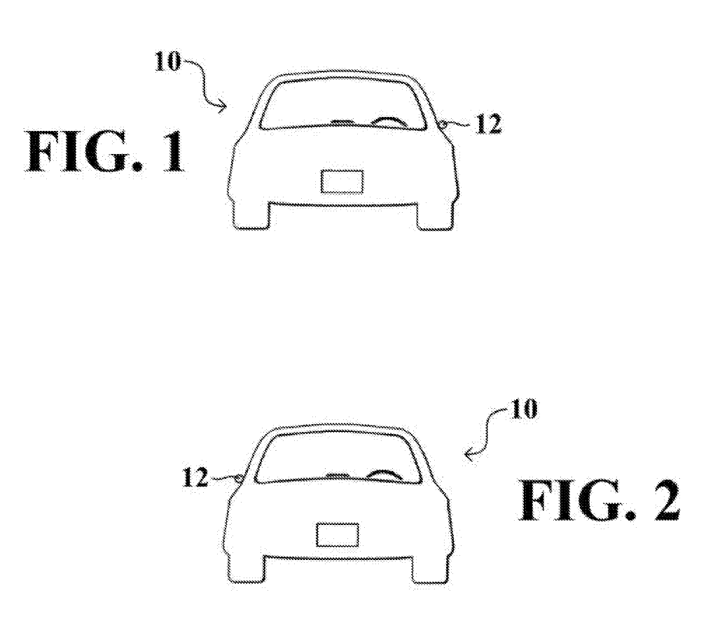

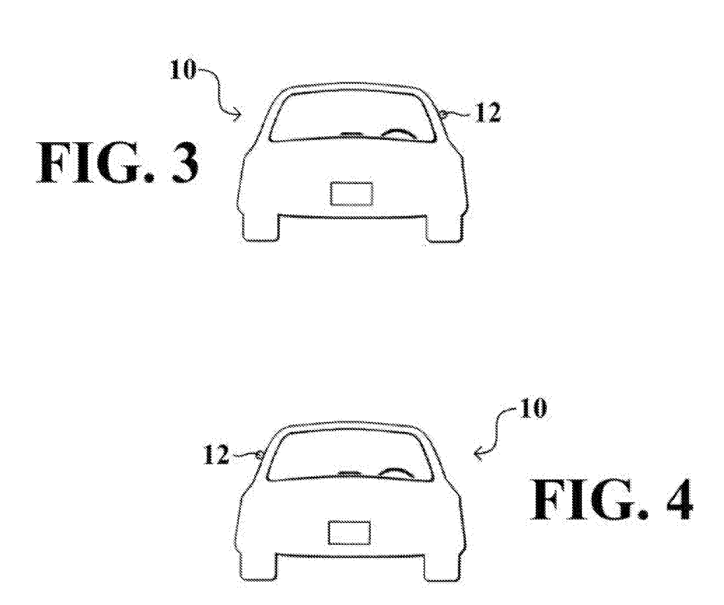

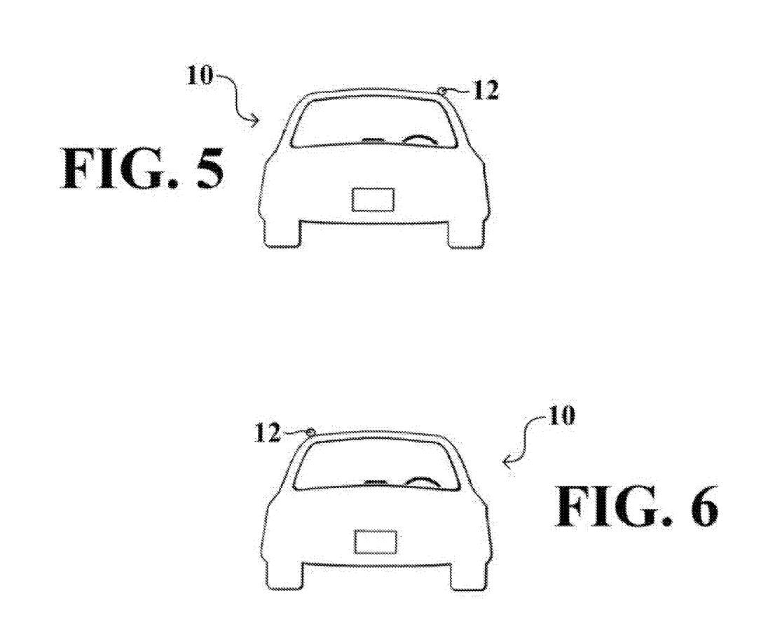

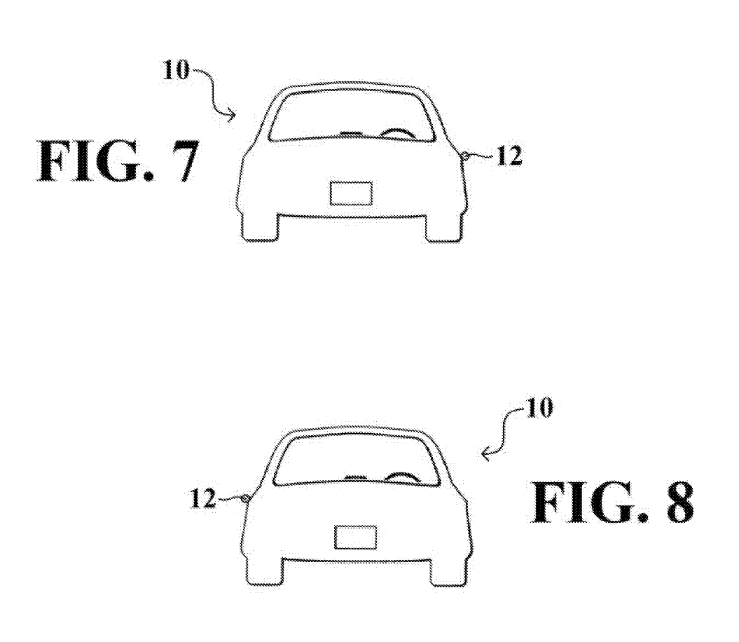

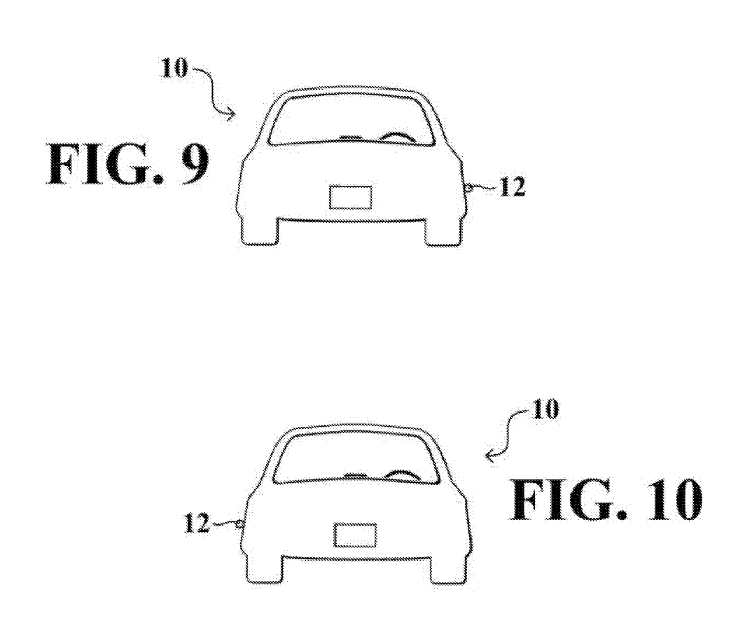

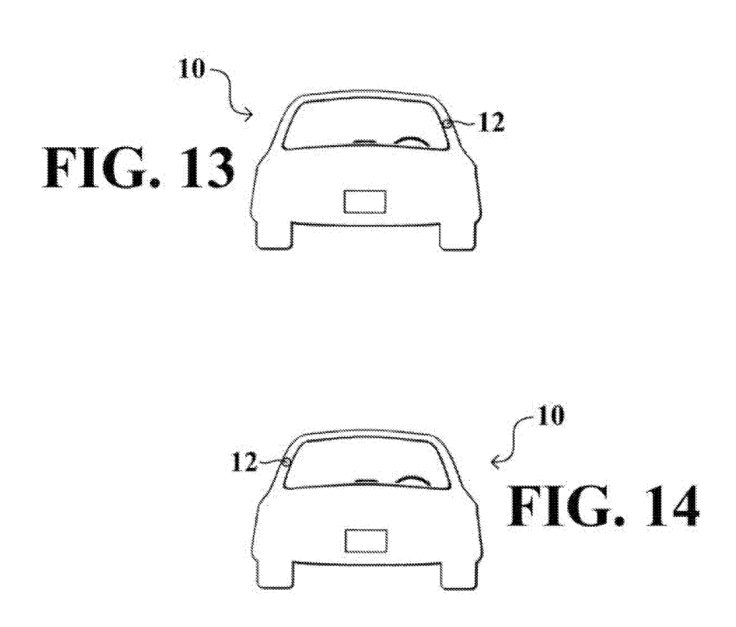

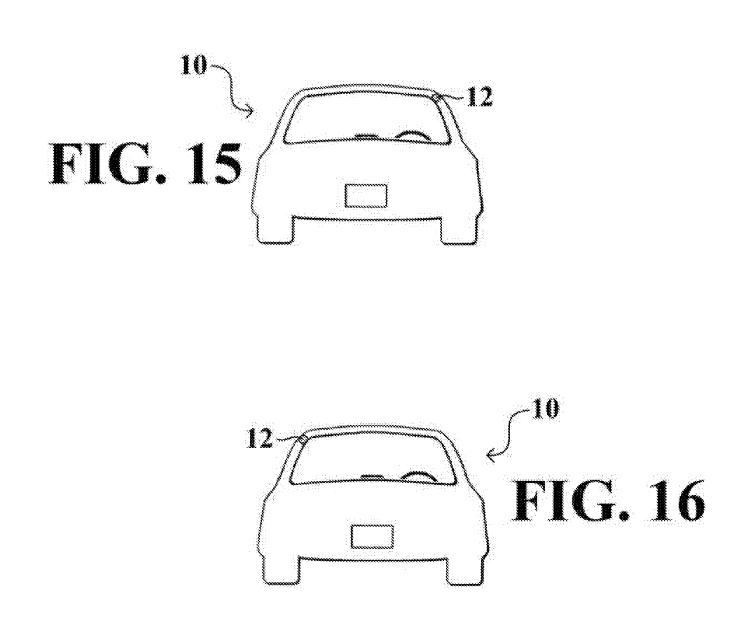

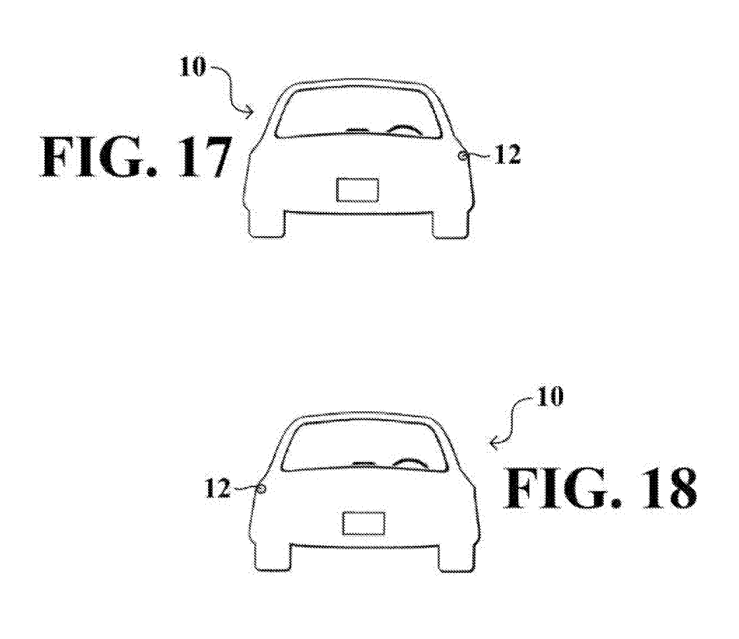

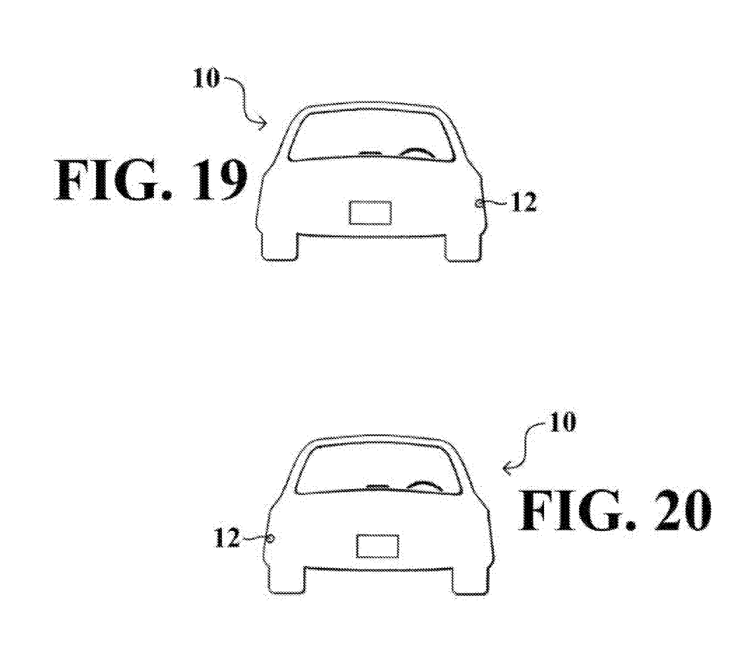

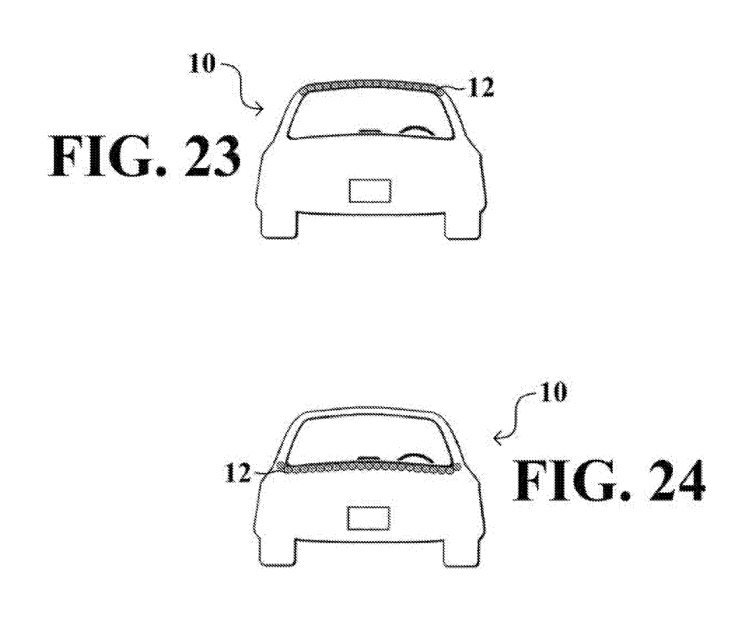

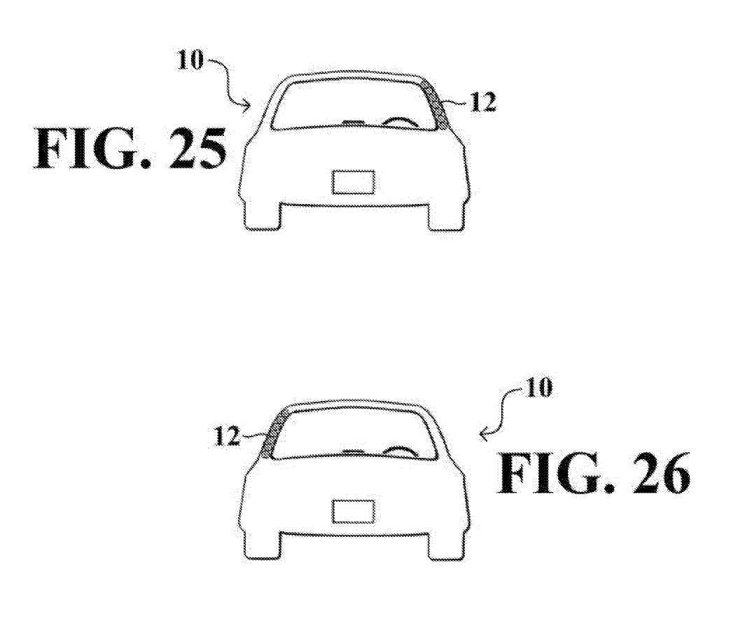

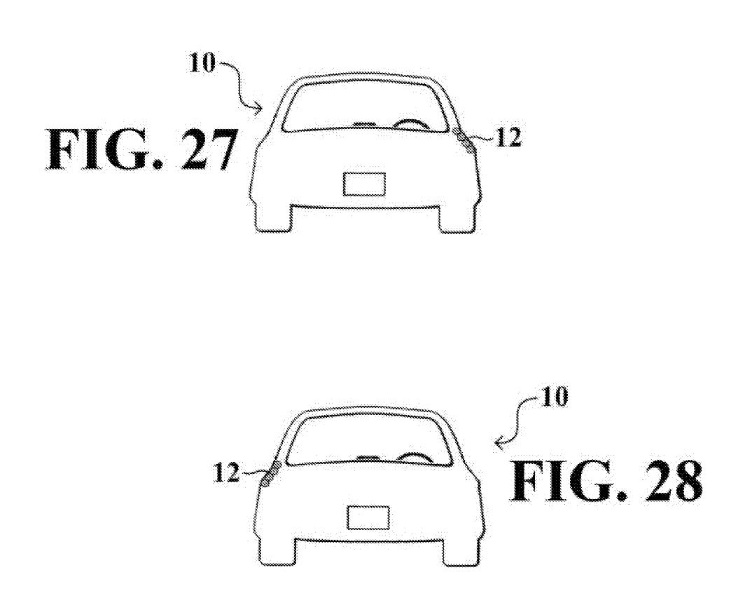

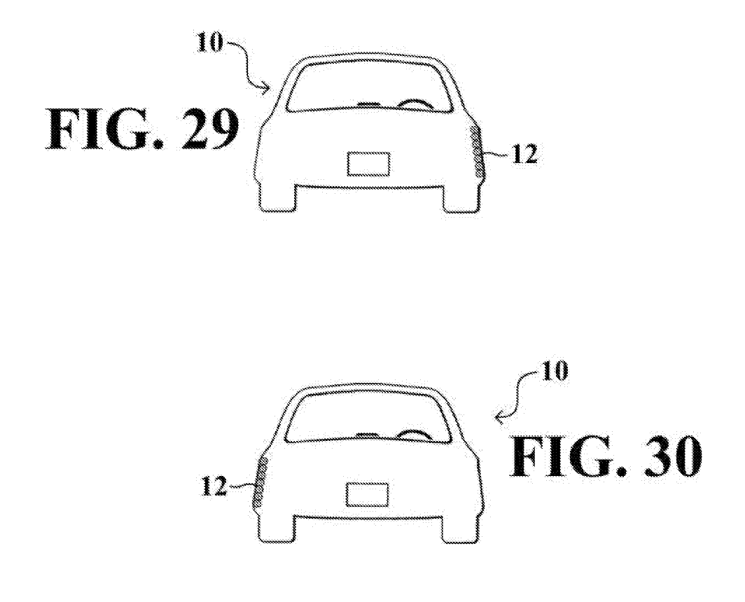

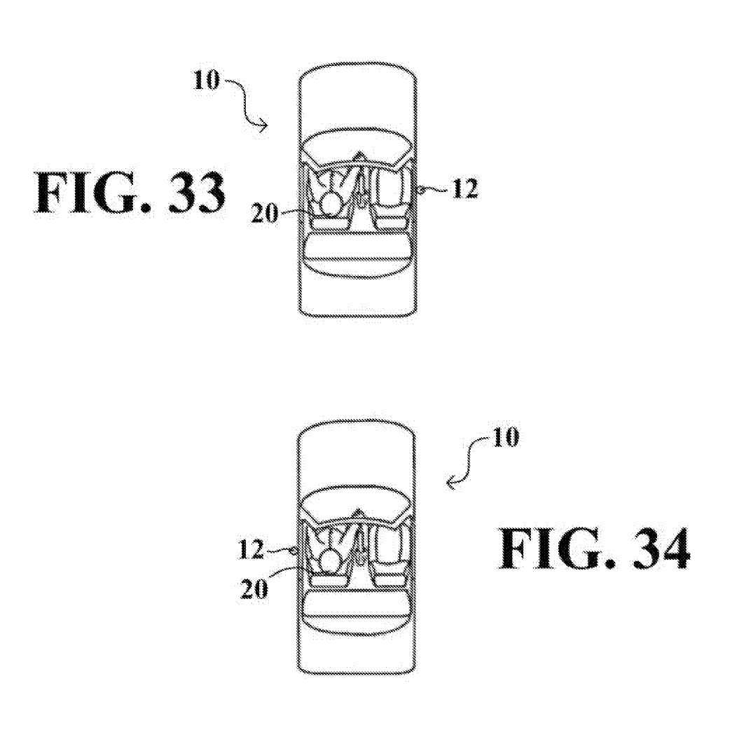

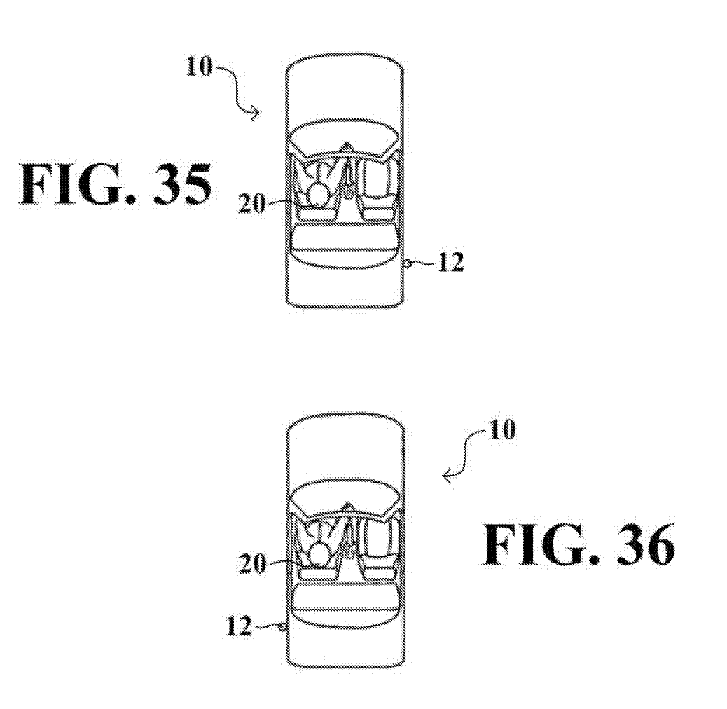

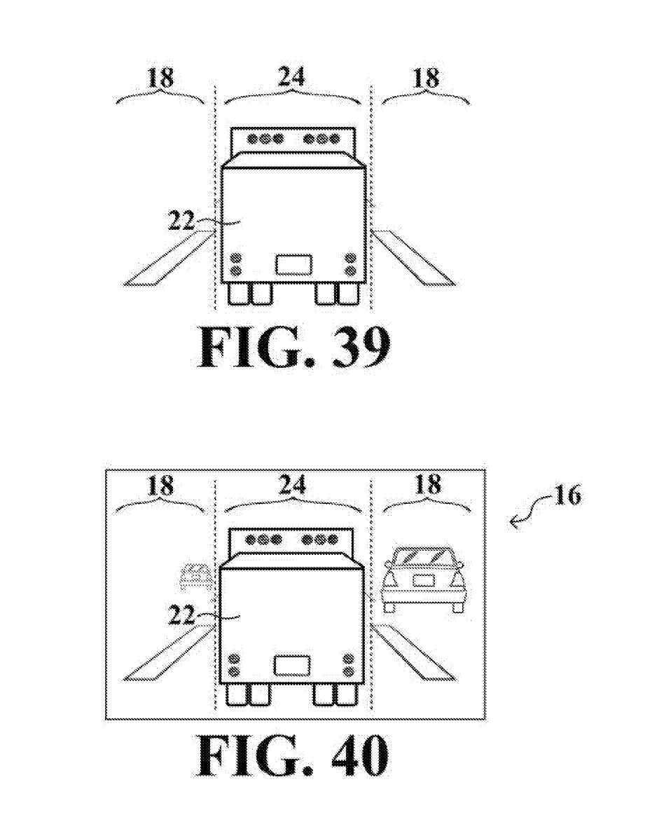

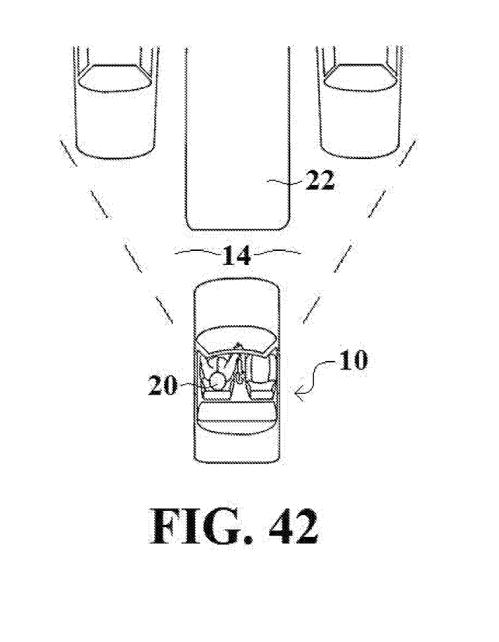

With reference now to the drawings, and in particular to FIGS. 1 through 42 thereof, a new forward vehicular vision system embodying the principles and concepts of the present invention will be described.

As best illustrated in FIGS. 1 through 42, the forward vehicular viewing system for a vehicle 10 generally comprises at least one optical instrument such as a camera, image sensor, fiber-optic apparatus, lensless compressive imaging architecture or other image input apparatus 12 and at least one display device such as a monitor, screen, plasma display panel, light-crystal display, light emitting diode, or other image output apparatus 16 for permitting a driver 20 using the system to see substantially forward 14 of the vehicle 10, extending and enhancing the available visual field.

The system comprises image input and image output means for acquiring and displaying the visual field substantially forward 14 of a vehicle 10. At least one image input apparatus 12 is located on the vehicle 10 having an image acquiring direction facing substantially forward 14 of the vehicle 10. At least one image output apparatus 16 is disposed within the vehicle 10 displaying a field of view directed substantially forward 14 of the vehicle 10.

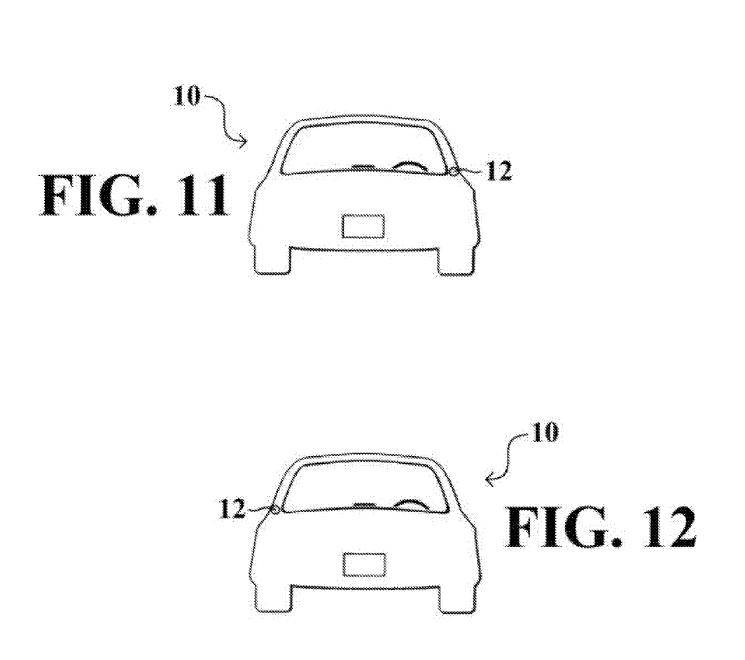

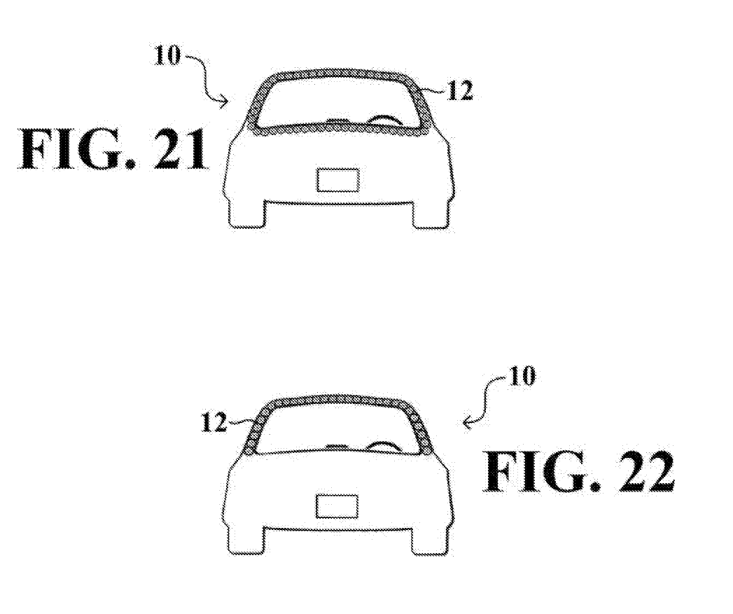

The at least one image input apparatus 12 could be mounted upon the vehicle 10, illustrated in FIGS. 1 through 10, or impressed within the vehicle 10, illustrated in FIGS. 11 through 20, at suitable positions of the vehicle 10. The at least one image input apparatus 12 could be individual acquisition input means, illustrated in FIGS. 1 through 20, or multi-view acquisition input means, illustrated in FIGS. 21 through 30.

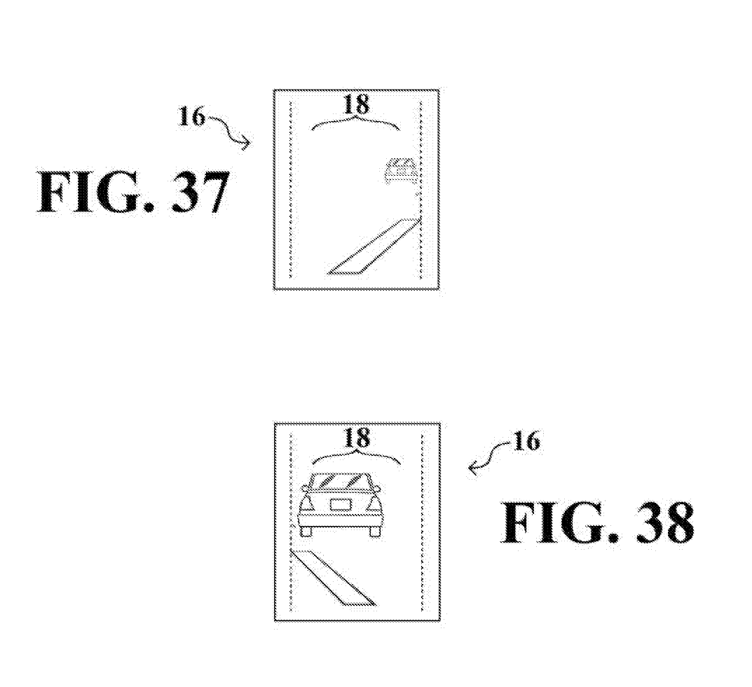

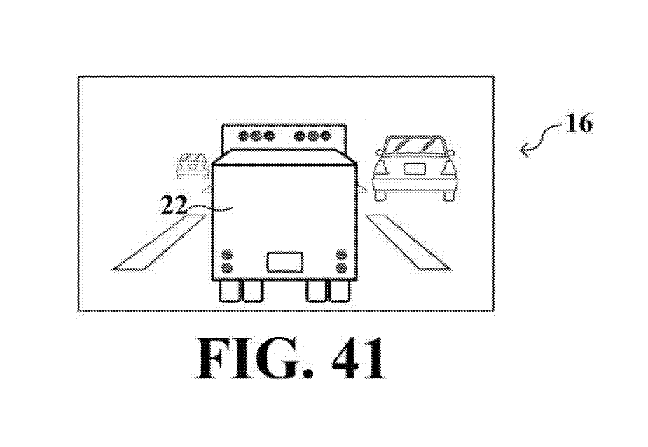

The at least one image output apparatus 16 could display an isolated image of a single blocked angle 18 of the visual field substantially forward 14 of the vehicle 10, illustrated in FIGS. 37 and 38, or an overall image such that a broad visual field substantially forward 14 including at least one blocked angle 18 of the vehicle 10, or both can be displayed, illustrated in FIGS. 40 and 41, within the vehicle 10. The at least one image output apparatus 16 is adapted for displaying to the driver 20 the visual field substantially forward 14 of the vehicle 10, also allowing the driver 20 to view a blocked angle 18 caused by an obstruction 22 that is blocking the visual field substantially forward 14, without having to significantly move the vehicle 10 into an adjacent lane. The forward vehicular vision system is constructed to provide the most effective visual field, beyond that which is visible in an obstructed line of sight 24, to include the area in a blocked angle 18.

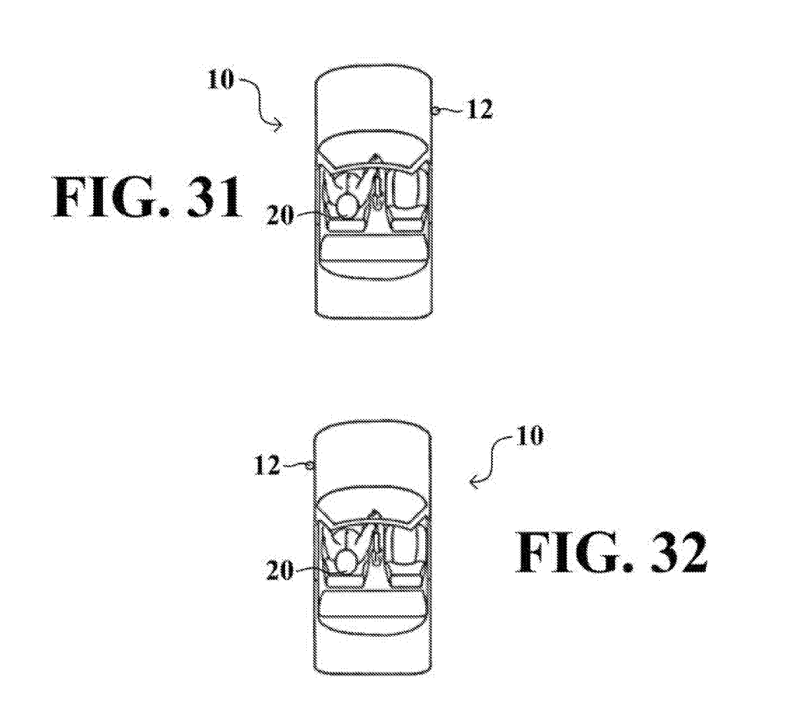

The positioning, quantity, and dimensions of the at least one image input apparatus 12 as well as the at least one image output apparatus 16 will be so that the combination of aesthetics, durability, reliability, and utility is optimum for each individual type, make, and/or model of vehicle. For example and without limitation, the at least one image input apparatus 12 can comprise any combination of number, location, size, measurement and/or type of input, in any embodiment. Additionally, the at least one image input apparatus 12 can be disposed in the forward-facing plane of the vehicle 10 and/or disposed anywhere along the side of the vehicle 10 upon the base area, the roof area, and/or the body area, the latter illustrated in FIGS. 31 through 36, in any embodiment. Also, the at least one image input apparatus 12 can be expanded or shortened, broadened or narrowed, particularly in regard to multi-view acquisition, in any embodiment. Moreover, the at least one image output apparatus 16 can be located on a door, window, windshield, display assembly, dashboard, and/or any other area within the interior of the vehicle 10 so as not to unduly obstruct or impede the driver's view in any embodiment, for optimization on a specific vehicle such as a car, jeep, van, bus, or truck.

Furthermore, the forward visual field area can be extended and enhanced using conventional and/or modern mechanisms (e.g. manual or automatic control for vertical/horizontal movement, tilt/pan, scale-up/scale-down, zoom-in/zoom-out, brightness/contrast, white balance, color temperature, smoothing, focus, stabilization, etc. and/or internal regulation for temperature, air, moisture, dew, fog, frost, weather conditions, etc.) known to those skilled in the art in order to optimize performance and functionality. Moreover, the forward vehicular vision system may contain additional features in order to optimize performance and functionality, such as rotatable or fixed apparatus(es), manual or automatic adjusting means, protrusion/retractability, control buttons, night vision, image enhancement, drive assist, etc. Even more, a manufacturer may carry several different configurations and/or parts of the forward vehicular vision system to accommodate the different angles associated with each different type of vehicle or each different vehicle make and model on which such system exists. Additionally, a manufacture may optionally choose to incorporate other mechanisms in combination with the present invention to include moving direction, driving intentions, distance detection, odometric data, graphic overlay, grid, scale, superimposed markings, topography, predicted travel locus, warning signals, recording means, storage means, collision prevention systems, other vehicular viewing systems, etc.

Thus, the reader will see that the present invention provides a method, system and device for a forward vehicular vision system that displays a visual field forward of a vehicle, the visual field forward including a blocked angle—an area that would otherwise be blocked by an obstruction in front of the vehicle. This method, system, and device will allow for safer roadways and is capable of being incorporated into present and future vehicular technology (e.g. mirrorless vehicles, autonomous vehicles, etc.) It is to be realized that the optimum dimensional relationships for the parts of the invention may include, but are not limited to, variations in size, materials, shape, form, function and manner of operation, assembly and use, all of which are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Furthermore, since numerous modifications and changes will readily occur to those skilled in the art, it is not desired to limit the invention to the exact construction and operation shown and described, and accordingly, all suitable modifications and equivalents may be resorted to, falling within the spirit and scope of the invention.

I claim:

1. A method for obtaining and displaying at least one forward image to be viewed within a vehicle, said method comprising:
providing at least one image input apparatus;
disposing said at least one image input apparatus upon said vehicle, effective to obtain said image or images;
providing at least one image output apparatus;
disposing said at least one image output apparatus within said vehicle, effective to display at least a portion of said image or images;
whereby said image or images directly display to the driver a visual field forward of the vehicle, the visual field forward of the vehicle including areas that would otherwise be blocked by an obstruction in front of the vehicle.

2. A system of forward-viewing for a vehicle, comprising:
at least one image input apparatus attached to a vehicle and having a field of view directed substantially forwardly of the vehicle;
at least one image output apparatus viewable by a driver of the vehicle which displays a field of view directed substantially forwardly of the vehicle;
whereby said image or images directly display to the driver a visual field forward of the vehicle, the visual field forward of the vehicle including areas that would otherwise be blocked by an obstruction in front of the vehicle.

3. A forward-view device for permitting a driver to see forward of a vehicle, the device comprising:
at least one image input apparatus attached to said vehicle which obtains a field of view directed substantially forwardly of the vehicle;
at least one image output apparatus attached within said vehicle which displays a field of view directed substantially forwardly of the vehicle;
whereby said image or images directly display to the driver a visual field forward of the vehicle, the visual field forward of the vehicle including areas that would otherwise be blocked by an obstruction in front of the vehicle.
